(19) United States
(12) Patent Application Publication
(10) Pub. No.: US 2009/0034267 A1
(43) Pub. Date: Feb. 5, 2009

(54) LED LAMP

(76) Inventor: Tang-Yueh HUNG, Taichung Hsien (TW)

Correspondence Address: SINORICA, LLC, 528 FALLSGROVE DRIVE, ROCKVILLE, MD, 20850, US

(21) Appl. No.: 11/830,017

(22) Filed: Jul. 30, 2007

(51) Int. Cl. F21V 5/00; F21V 15/01

(52) U.S. Cl. 362/311; 362/362

(57) ABSTRACT

An LED lamp includes a hollow housing, at least one circuit board, several LED, two conductive plates and a cap. The LED are mounted under a bottom face of the circuit board. The circuit board and the LED are all installed in the housing with the LED located at a bottom end of the housing. The conductive plates are mounted in the housing. The top ends of the conductive plates protrude from a top end of the housing, while the bottom ends of the conductive plates are electrically connected with the circuit board. The cap is detachably fitted on the top end of the housing. The LED lamp is inbuilt with LED so that it is unnecessary to further install any LED bulb. Multiple LED lamps can be easily serially connected to increase the brightness.

### BACKGROUND OF THE INVENTION

The present invention is related to a lamp, and more particularly to an LED lamp.

It is known that LED can emit light at low power consumption. Therefore, it is a trend to replace the traditional lamp with LED. In general, LED is manufactured to have a form of bulb. Under such circumstance, in use, LED must be seated in a bulb socket. This is inconvenient.

Furthermore, the conventional LED lamp can not be serially connected or parallelly connected. Therefore, the brightness of the LED lamp is fixed and unadjustable. In the case that higher brightness is needed, the illumination provided by the conventional LED equipment will be insufficient.

### SUMMARY OF THE INVENTION

It is therefore a primary object of the present invention to provide a lamp which is inbuilt with LED.

It is a further object of the present invention to provide the above LED lamps which can be connected with each other to increase the brightness.

The present invention can be best understood through the following description and accompanying drawings wherein:

### BRIEF DESCRIPTION OF THE DRAWINGS

FIG. 1 is a perspective assembled view of the LED lamp of the present invention;

FIG. 2 is a perspective exploded view of the LED lamp of the present invention;

FIG. 3 is a top view according to FIG. 1;

FIG. 4 is a sectional view taken along line 4-4 of FIG. 3;

FIG. 5 is a side view according to FIG. 1, in which one half of the housing of the LED lamp is removed;

FIG. 6 is a sectional view taken along line 6-6 of FIG. 3;

FIG. 7 shows that several LED lamps of the present invention are connected;

FIG. 8 is a perspective exploded view of another embodiment of the LED lamp of the present invention, showing that several LED lamps are connected;

FIG. 9 shows a circuit diagram used in the invention; and

FIG. 10 shows another circuit diagram used in the invention.

### DETAILED DESCRIPTION OF THE PREFERRED EMBODIMENTS

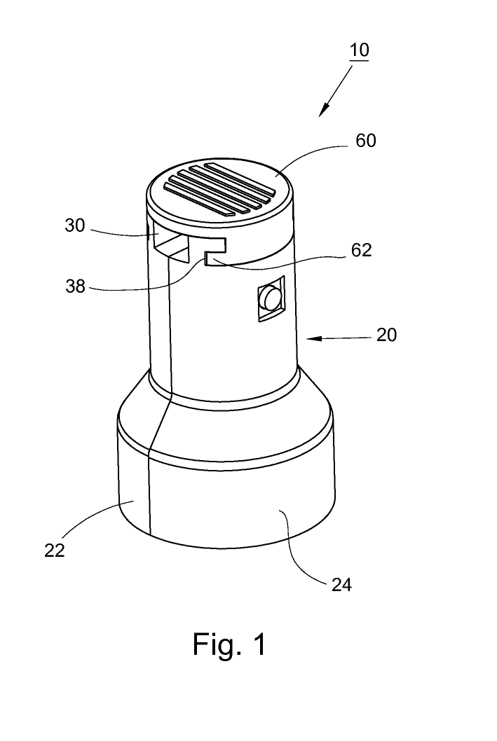

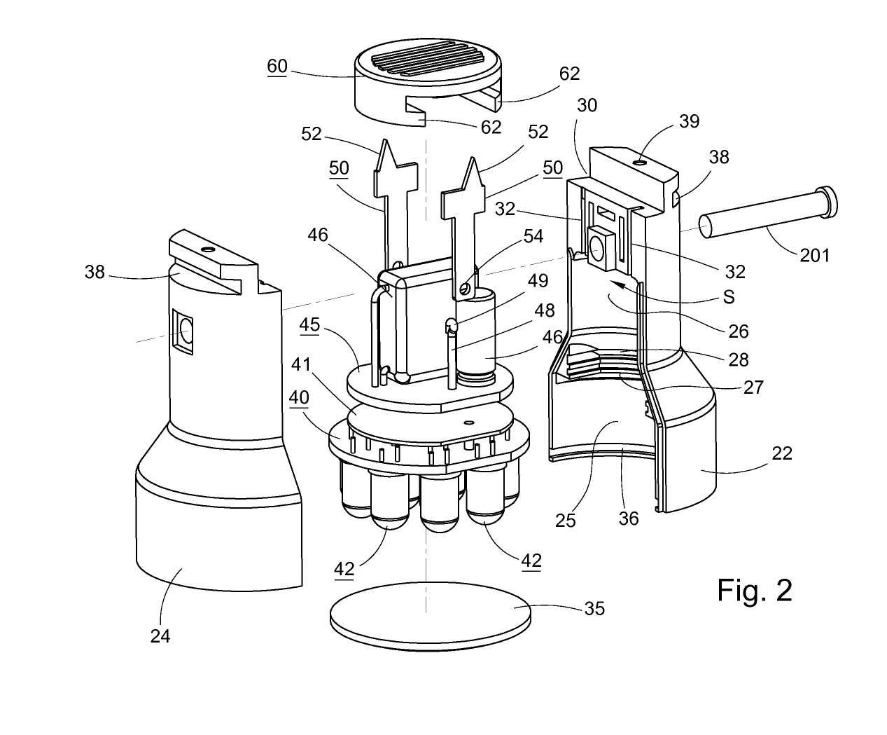

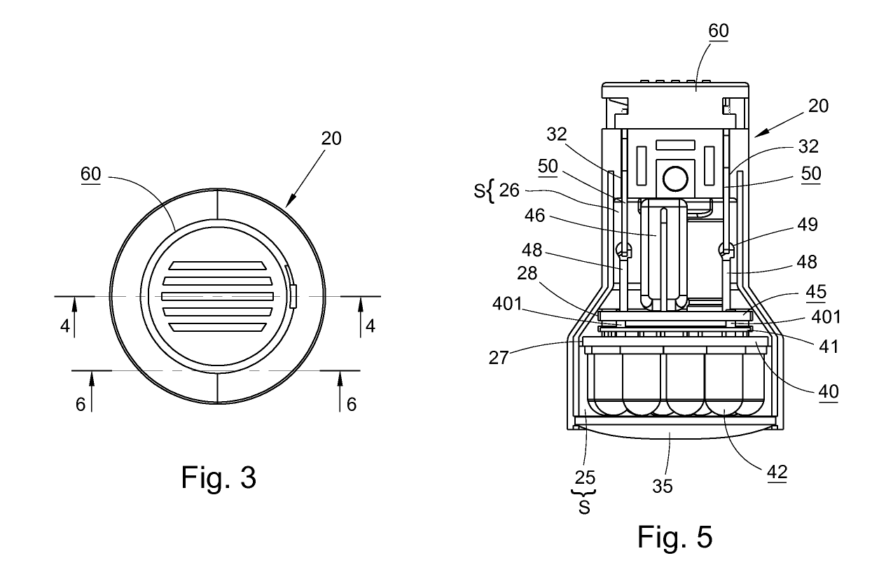

Please refer to FIGS. 1 and 2. According to a preferred embodiment of the present invention, the LED lamp 10 includes a housing 20 and LED, circuit boards and conductive plates installed in the housing 20.

The housing 20 is composed of two symmetric halves 22, 24 mated with each other. The two halves 22, 24 are locked with each other by means of a screw member or a rivet 201. A bottom end of the housing 20 is an open end. The housing is hollow and has a receiving space S. Two locating sections 27, 28 are formed on inner wall face of the housing 20 to define the receiving space S into a lower chamber 25 and an upper chamber 26. The lower chamber 25 is located at the bottom end of the housing 20, while the upper chamber 26 is closer to a top end of the housing. The two locating sections are grooved structures. The lower locating section 27 is near the lower chamber 25, while the upper locating section 28 is near the upper chamber 26. A passage 30 is formed at the top end of the housing to pass through the housing from front side to rear side thereof. Two insertion slits 32 are vertically side by side formed in the housing. Top ends of the insertion slits 32 communicate with the passage 30, while bottom ends of the insertion slits 32 communicate with the upper chamber 25.

In practice, each of the receiving space, the locating sections, the passage, the insertion slits and the chambers is divided into two halves respectively formed in the two halves of the housing.

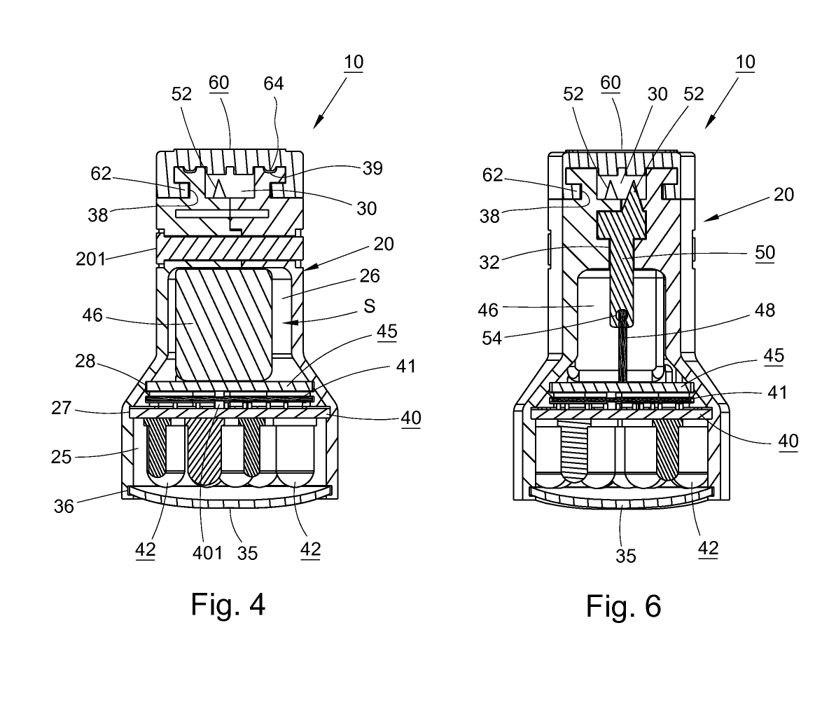

Two circuit boards 40, 45 are horizontally parallelly arranged and electrically connected with each other via connecting wires 401 as shown in FIGS. 4 and 5. The two circuit boards are separated from each other by an insulating board 41. The two circuit boards are printed with circuits. Several LED 42 are soldered under a bottom face of the lower circuit board 40. Several electronic elements 46 are soldered on a top face of the upper circuit board 45. The circuit boards 40, 45 together with the LED 42 and the electronic elements 46 are installed in the receiving space S of the housing 20. The lower circuit board 40 is positioned in the lower locating section 27 as shown in FIG. 4, while the upper circuit board 45 is positioned in the upper locating section 28. The insulating board 41 is positioned in an annular groove between the locating sections 27, 28. The LED 42 are positioned in the lower chamber 25, while the electronic elements 46 are positioned in the upper chamber 26.

A lens 35 is inlaid in an annular groove 36 of the housing 20 to block the open bottom end of the housing 20. The light emitted from the LED can pass through the lens 35.

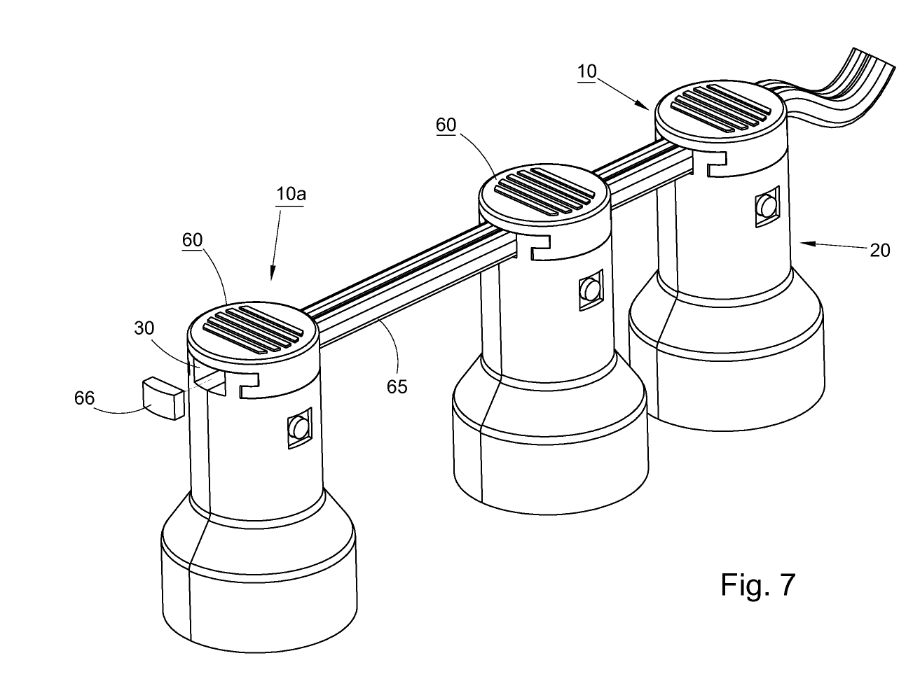

Each of two conductive plates 50 has a top end formed with a sharp thrust section 52. The two conductive plates 50 are respectively installed in the two insertion slits 32 and located in the housing 20. Bottom ends of the conductive plates are electrically connected with the upper circuit board 45 to serve as a positive electrode and a negative electrode. The two thrust sections 52 protrude into the passage 30 as shown in FIG. 6. The two thrust sections 52 are respectively positioned on two sides of the passage 30 and not aligned with each other. In this embodiment, two contact pins 48 are arranged on the top face of the upper circuit board 45. Each contact pin 48 has a top end formed with a hook section 49 hooked in a hole 54 of a bottom end of the conductive plate 50 for conducting current.

A cap 60 is detachably fitted on the top end of the housing 20 to block a top side of the passage 30. In this embodiment, each of two sides of the cap 60 is formed with a downward extending insertion section 62. The insertion sections 62 are inserted in two channels 38 of two sides of the top end of the housing 20. Accordingly, the cap 60 can be detachably assembled with the housing. Two protuberances 64 are formed under bottom face of the cap 60 as shown in FIG. 4. The protuberances 64 are engaged in two dents 39 of a top face of the housing to locate the cap 60.

The above components are assembled to form a lamp with LED. The LED lamp can be connected to a power source and then used indoors or outdoors. The top ends of the conductive plates 50 can be connected to an AC power to light up the LED.

The LED lamp 10 can be solely used. When it is necessary to increase the illumination and widen the illumination range, multiple LED lamps can be serially connected. FIG. 7 shows that the LED lamp is connected with a wire and several LED lamps are serially connected. In this case, the caps 60 of the LED lamps are separated from the housings 20. Then a wire 65 is placed into the passages 30 of the housings. Referring to FIG. 6, it can be understand that the thrust sections 52 of the conductive plates 50 thrust through the skin of the wire 65 when it is placed into the passage. The two thrust sections 52 are not aligned with each other so that the two thrust sections 52 just respectively contact with two strands of the wire. Then, the caps 60 are again fitted on the top ends of the housings 20 to prevent the wire from getting out of the passages 30. Accordingly, the lamp is easily connected with a wire; the LED lamps can be easily serially connected and the number of the serially connected LED lamps is not limited.

In addition, two plugs 66 can be respectively plugged into the free ends of the passages 30 of the first LED lamp 10a and the last LED lamp 10a to keep a tidy appearance.

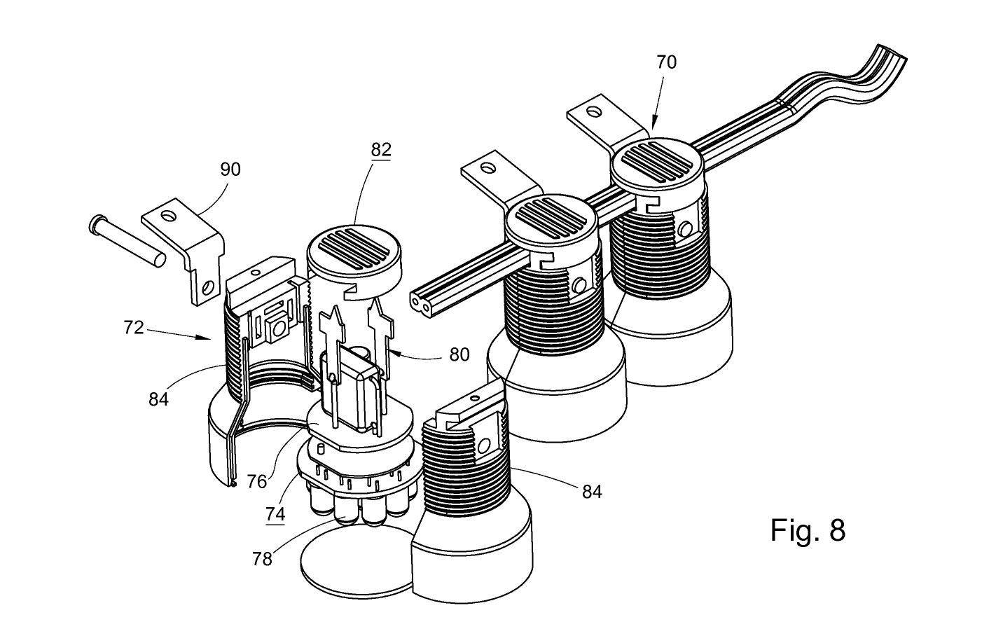

FIG. 8 shows another embodiment of the present invention, showing a serially connected state thereof. In this embodiment, the LED lamp 70 includes a housing 72, two circuit boards 74, 76, LED 78, two conductive plates 80 and a cap 82. These components are identical to those of the above embodiment.

In this embodiment, an outer circumference of the housing 72 is formed with a thread 84. Accordingly, the LED lamp 70 can be screwed and fixed in a certain position. Alternatively, a connecting member 90 such as an iron plate can be fixed on the outer circumference of the housing 72. By means of the connecting member 90, the LED lamp can be mounted in a certain position.

It should be noted that in practice, the two circuit boards can be integrated into one piece and the LED and the electronic elements are respectively soldered on a bottom face and a top face of the circuit board.

According to the above arrangement, the LED lamp is directly inbuilt with LED and can be directly used. Therefore, it is unnecessary to further install any LED bulb. The power consumption of such LED lamp is much lower than that of the traditional lamp employing conventional bulb.

The LED lamp of the present invention can be solely used. Alternatively, multiple LED lamps can be serially connected to increase the brightness. It is easy to serially connect the LED lamps.

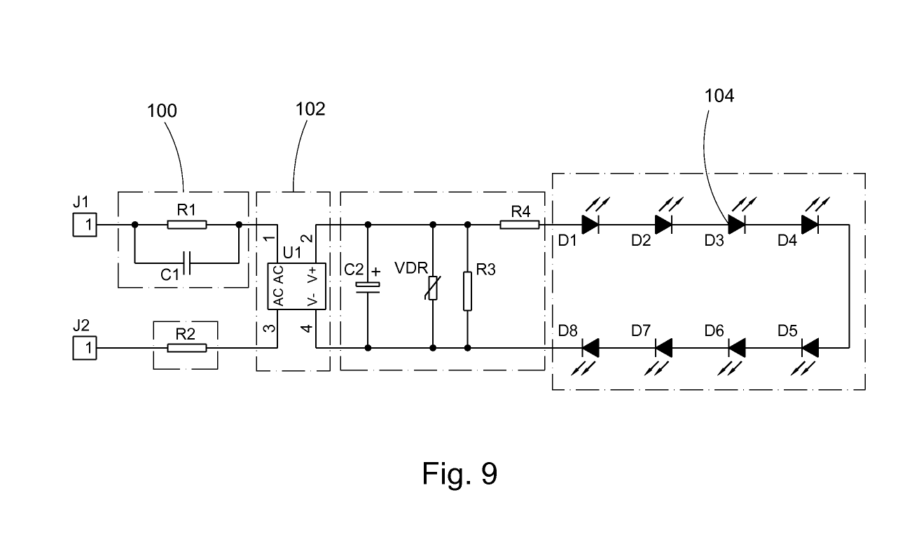

FIG. 9 shows a circuit device used in the present invention, which includes a pull-down circuit 100, a rectifier circuit 102 and several series-connected LED 104.

J1 and J2 are contacts. The pull-down circuit 100 comprises a resistor R1 and a capacitor C1. A resistor R2 offers a current-limiting effect and protects the circuit device from short circuit just like a fuse. The U1 of the rectifier circuit 102 is a bridge rectifier (rectifying diode). A capacitor C2 provides a filtering effect. A surge absorber VDR protects the LED 104 from impulse voltage.

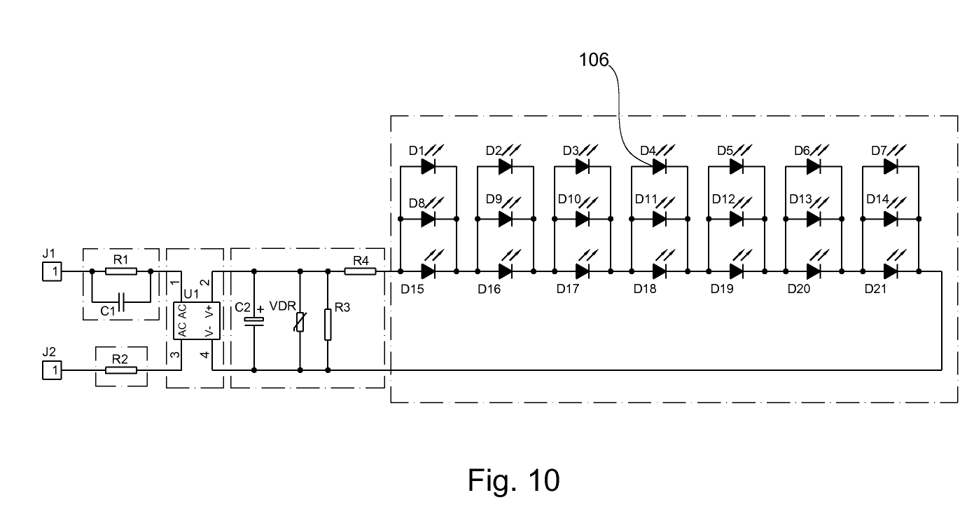

FIG. 10 shows another circuit device used in the present invention in which the LED 106 are series-parallel connected.

The above embodiments are only used to illustrate the present invention, not intended to limit the scope thereof. Many modifications of the above embodiments can be made without departing from the spirit of the present invention.

What is claimed is:

1. An LED lamp comprising:
a housing having a bottom end which is an open end, the housing being hollow, having a lower chamber and an upper chamber communicating with each other, the lower chamber being located at the bottom end of the housing, while the upper chamber being closer to a top end of the housing; at least one locating section being formed on inner wall face of the housing between the lower chamber and the upper chamber; a passage being formed at the top end of the housing to pass through the housing from a front side to a rear side thereof; two insertion slits being side by side formed in the housing, top ends of the insertion slits communicating with the passage, while bottom ends of the insertion slits communicating with the upper chamber;
at least one circuit board;
several LED mounted on a bottom face of the circuit board and several electronic elements electrically connected with the circuit of the circuit board, the circuit board together with the LED and the electronic elements being installed in the housing, the circuit board being positioned in the locating section, the LED being located in the lower chamber, while the electronic elements being located in the upper chamber;
two conductive plates each having a top end formed with a thrust section, the two conductive plates being respectively installed in the two insertion slits, bottom ends of the conductive plates being electrically connected with the circuit board; the two thrust sections protruding into the passage, the thrust sections being respectively positioned on two sides of the passage and not aligned with each other; and
a cap detachably fitted on the top end of the housing to block a top side of the passage.

2. The LED lamp as claimed in claim 1, wherein two contact pins are arranged on the top face of the circuit board; the bottom ends of the conductive plates being respectively connected with the contact pins.

3. The LED lamp as claimed in claim 1, wherein an upper locating section and a lower locating section are formed on inner wall face of the housing between the lower chamber and the upper chamber; a lower circuit board and an upper circuit board being horizontally parallelly arranged and electrically connected with each other, the lower circuit board being positioned in the lower locating section, while the upper circuit board being positioned in the upper locating section; the LED being mounted on a bottom face of the lower circuit board, while the electronic elements being mounted on a top face of the upper circuit board; the bottom ends of the conductive plates being electrically connected with the upper circuit board.

4. The LED lamp as claimed in claim 3, wherein two contact pins are arranged on the top face of the upper circuit board; the bottom ends of the conductive plates being respectively connected with the contact pins.

5. The LED lamp as claimed in claim 1, wherein each of two sides of the cap is formed with a downward extending insertion section; two channels being respectively formed on two sides of a top end of the housing; the insertion sections of the cap being respectively inserted in the channels.

6. The LED lamp as claimed in claim 5, wherein at least one protuberance is formed on a bottom face of the cap; at least one dent being formed on a top face of the housing, whereby the protuberance is engaged in the dent to locate the cap.

7. The LED lamp as claimed in claim 1, further comprising a lens mounted at a bottom end of the housing.

8. The LED lamp as claimed in claim 3, wherein the two circuit boards are separated from each other by an insulating board.

9. The LED lamp as claimed in claim 1, further comprising a plug which is plugged in one end of the passage.

10. The LED lamp as claimed in claim 1, wherein an outer circumference of the housing is formed with a thread.

11. An LED lamp comprising:
a hollow housing having an open bottom end and an internal receiving space, a bottom end of the receiving space communicating with the open bottom end of the housing; at least one locating section being formed on inner wall face of the housing in the receiving space; two insertion slits being side by side formed in the housing, top ends of the insertion slits extending to a top face of the housing, bottom ends of the insertion slits communicating with the receiving space;
at least one circuit board;
several LED mounted on a bottom face of the circuit board, the circuit board and the LED being installed in the receiving space, the circuit board being positioned in the locating section, the LED being located at a bottom end of the housing; and
two conductive plates respectively installed in the two insertion slits, top ends of the conductive plates protruding from a top end of the housing, while bottom ends of the conductive plates being electrically connected with the circuit board.

12. The LED lamp as claimed in claim 11, further comprising a cap detachably fitted on the top end of the housing; a passage being formed between the cap and the housing, two ends of the passage being respectively located on a front side and a rear side of the LED lamp, the top ends of the conductive plates being located in the passage.

13. The LED lamp as claimed in claim 11, further comprising several electronic elements electrically connected with the circuit board and located in the receiving space.

14. The LED lamp as claimed in claim 13, wherein an upper locating section and a lower locating section are formed on inner wall face of the housing; a lower circuit board and an upper circuit board being horizontally parallelly arranged and electrically connected with each other, the lower circuit board being positioned in the lower locating section, while the upper circuit board being positioned in the upper locating section; the LED being mounted on a bottom face of the lower circuit board; the electronic elements being connected with the upper circuit board; the bottom ends of the conductive plates being electrically connected with the upper circuit board.

15. The LED lamp as claimed in claim 12, wherein the top end of each conductive plate has a thrust section, the thrust sections being respectively located on two sides of the passage and not aligned with each other.

16. The LED lamp as claimed in claim 11, further comprising a lens mounted at a bottom end of the housing.

17. The LED lamp as claimed in claim 11, wherein two contact pins are arranged on the top face of the circuit board; the bottom ends of the conductive plates being respectively connected with the contact pins.

18. The LED lamp as claimed in claim 13, wherein the two circuit boards are separated from each other by an insulating board.

19. The LED lamp as claimed in claim 11, further comprising a plug which is plugged in one end of the passage.

20. The LED lamp as claimed in claim 11, wherein an outer circumference of the housing is formed with a thread.
